(19) United States
(12) Patent Application Publication
(10) Pub. No.: US 2010/0042734 A1
(43) Pub. Date: Feb. 18, 2010

(54) PROXY SERVER ACCESS RESTRICTION APPARATUS, SYSTEMS, AND METHODS

(76) Inventors: Atli Olafsson, San Marcos, CA (US); Jonathan McKinney, San Diego, CA (US); Robert W. Fransdonk, Amstelveen (NL); Shawn Michels, Carlsbad, CA (US); Greg Hammill, Carlsbad, CA (US); Scott Richard Crowder, Carlsbad, CA (US)

Correspondence Address: SCHWEGMAN, LUNDBERG & WOESSNER, P.A., P.O. BOX 2938, MINNEAPOLIS, MN, 55402, US

(21) Appl. No.: 12/104,335

(22) Filed: Apr. 16, 2008

Related U.S. Application Data
(60) Provisional application No. 60/969,449, filed on Aug. 31, 2007.

(51) Int. Cl. G06F 15/16

(52) U.S. Cl. 709/229

(57) ABSTRACT

Apparatus, systems, and methods disclosed herein disallow connections from one or more remote clients associated with an Internet protocol (IP) address for a period of disallowance if a number of connection requests from the one or more clients associated with the IP address exceeds a threshold number during a threshold time period. Other embodiments are described and claimed.

### PRIORITY

This disclosure claims the benefit of the filing date of Provisional Patent Application Ser. No. 60/969,449 (Attorney Docket No. 2059.036PRV) filed on Aug. 31, 2007 and titled “Proxy Server Access Restriction Apparatus, Systems, and Methods, commonly assigned to the assignee of the instant application, Entriq, Inc.

### TECHNICAL FIELD

Various embodiments described herein relate to apparatus, systems, and methods associated with network security, including limiting access to protected content.

### BACKGROUND INFORMATION

Traditionally, Internet content may be freely accessible or may require a login account for access. Password protected login accounts may be used by content providers to collect per-user fees, to track usage, to collect marketing information, etc. These goals may be frustrated, however, if an account holder shares her login information with others, such as with family members or corporate users behind a firewall. Absent rules to the contrary, multiple remote clients may access the protected content using the proxy Internet protocol (IP) address of the firewall.

Traditional login accounts may not be well-suited for certain types of content distribution, including mass-audience single-occurrence events. For example, a U.S. television network may broadcast a major sporting event in real time across U.S. time zones via radio frequency broadcast and network cable. The event organizer may license the U.S. television network to make available a delayed feed of the event in the U.S. via the Internet. The event organizer may also license a foreign television network to broadcast the event in a foreign country via traditional television channels the following day. If the content is accessible by Internet clients in the foreign country before the broadcast in that country the following day, the delayed Internet feed might preempt advertising revenues for the foreign television network. The possibilities may be further complicated by the use of a virtual private network (VPN) extending from the foreign country to a city in the U.S. In the latter case, the accessing IP address may be associated with the U.S. end of the VPN and may thus correspond to a North American geographical area. However, a large number of remote clients at the foreign end of the VPN may access the content intended for U.S. distribution, perhaps in violation of licensing agreements.

### BRIEF DESCRIPTION OF THE DRAWINGS

FIG. 1 is a block diagram of an apparatus and a system according to various embodiments of the invention.

FIGS. 2A and 2B are flow diagrams illustrating several methods according to various embodiments of the invention.

FIG. 3 is a block diagram of a computer readable medium (CRM) according to various embodiments.

### DETAILED DESCRIPTION

Embodiments herein restrict access to content or to server-based applications by throttling the rate at which remote clients using the same IP address are permitted to connect to receive the content or to access the applications. That is, an access restriction paradigm is implemented wherein access to the content from multiple remote clients using a single IP address is allowed, but only up to a certain number of connections during a given time interval. This access paradigm, working alone or in conjunction with geographic area IP filtering and/or login account control, may prove beneficial in various environments.

For example, a traditional television broadcaster may wish to make previously-broadcast content available on the Internet some time after the traditional radio-frequency and/or cable broadcast. However, the broadcaster may wish to limit Internet availability of the content to certain geographic regions. Embodiments herein may combine IP address rate-of-connection methods with geographic area filtering techniques to exercise this level of connection control for a potentially very large number of connections without requiring resource-intensive login authentication.

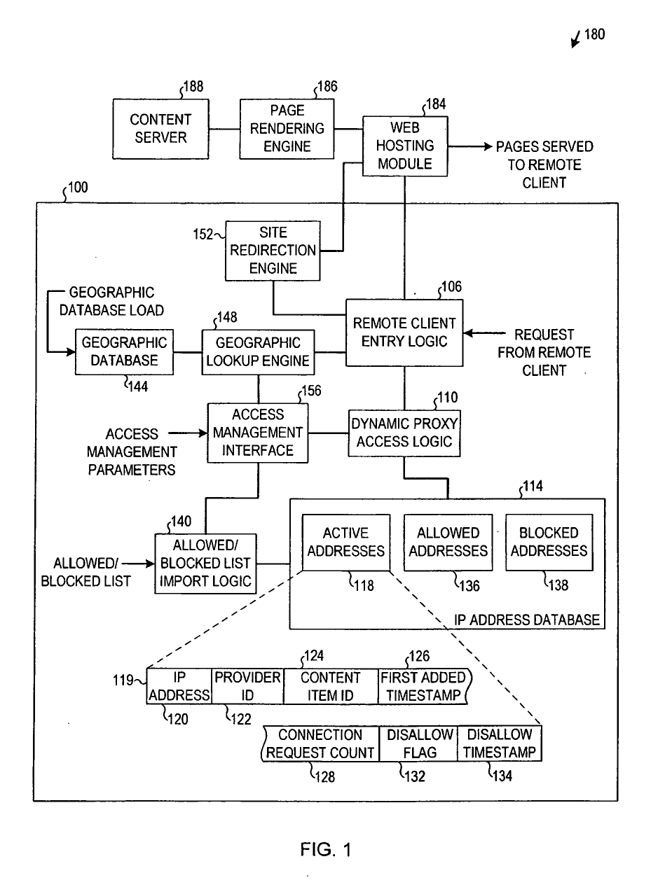

FIG. 1 is a block diagram of an apparatus 100 and a system 180 according to various embodiments of the invention. In some embodiments, the apparatus 100 may be included in a content hosting environment. Although examples herein may refer to content accessed via the World-wide Web (“Web”), concepts and structures associated with the apparatus 100 may be used to control access to packet-distributed content generally.

The apparatus 100 may include remote client entry logic 106. The remote client entry logic 106 may receive a request from one or more remote clients associated with a particular IP address. The remote clients may request a connection to receive protected content. Multiple connection requests from the same IP address may occur if the IP address is associated with a proxy agent such as a firewall or a VPN, for example.

The apparatus 100 may also include dynamic proxy access logic 110 coupled to the remote client entry logic 106. The dynamic proxy access logic 110 disallows additional connections to receive the content for a period of disallowance if a number of connection requests from the remote clients exceeds a threshold number during a threshold time period. For example, additional connections may be disallowed for 30 minutes if more than five connection requests are received from the same IP address during a threshold period of ten minutes. Other configurations may use other threshold numbers, threshold periods, and periods of disallowance. These parameters may be configurable in some embodiments. Some embodiments contemplated herein may use other mechanisms to throttle connection rates from remote clients using the same IP address.

The apparatus 100 may also include an IP address database 114 coupled to the dynamic proxy access logic 110. The IP address database 114 may comprise an active address table 118 to store IP addresses and associated connection requests from the remote clients. A record 119 from the active address table 118 may comprise an IP address field 120 containing the particular IP address. The record 119 may also comprise one or more of a provider field 122 containing a provider identifier, a content item field 124 containing a content item identifier, a first-added timestamp field 126, a connection request count field 128, a disallow flag 132, and a disallow timestamp field 134.

Some embodiments may combine records of connection requests for multiple items of content, content supplied by multiple content providers, or both, into a single active address table 118. “Content item” as used herein means a separately accessible item of content, such as a movie, a sporting event, a musical concert, an audio track, etc. A multiple-provider, multiple-content item database may be well-suited to a content hosting environment. The provider identifier and the content item identifier may be used by structures associated with the apparatus 100 to isolate entries in the active address table 118 to a particular content item offered by a particular content provider. For example, a content provider ABC may offer multimedia presentations P123, P234, and P345 simultaneously. At the same time, a content provider XYZ may offer presentations P456 and P567.

The apparatus 100 may receive a first connection request for a particular item of content in the form of a packet with a particular IP address. The dynamic proxy access logic 110 may respond to the connection request by creating the record 119 associated with the IP address in the active address table 118. The access logic 110 may write the IP address into the IP address field 120. The access logic 110 may also write a first-added timestamp corresponding to the time of arrival of the first connection request into the first-added timestamp field 126, and may set the connection request count field 128 to one.

The dynamic proxy access logic 110 may use a set of risk profile configuration parameters to determine whether to allow additional requests for the particular item of content from packets with a source address equal to the IP address entered into the IP address field 120. If additional requests are disallowed, the access logic 110 may determine the period of disallowance. The risk profile configuration parameters may include the threshold number, the threshold period, and the period of disallowance.

The access logic 110 may respond to the additional requests by incrementing the connection request count field 128 by one for each such request. The access logic 110 may calculate a time difference between the time of arrival of the first connection request and the time of arrival of a subsequent connection request. If the time difference is less than the threshold period and the connection request count field 128 contains a count greater than the threshold number, the access logic 110 may disallow the additional request and subsequent additional requests for the period of disallowance. In some embodiments, the first-added timestamp, the connection request count, and/or the disallow flag may be reset following the period of disallowance. Alternatively, the record associated with the IP address in the active address table 118 may be deleted.

Some embodiments may exercise finer control granularities by implementing tiered threshold levels. A two-level dynamic access control system may continue to increment the connection request count as additional connection requests are received following the start of a period of disallowance. Should the connection request count reach a second threshold during a second threshold period, the dynamic proxy access logic 110 may impose a longer, second period of disallowance.

Extending the example above for a two-tiered case, suppose that a first period of disallowance of 30 minutes is imposed because more than five connection requests are received from the same IP address during a first threshold period of ten minutes. Now suppose that during the 30-minute period of disallowance a second threshold of 50 connection requests is exceeded. The access logic 110 may then impose a second period of disallowance of e.g., 24 hours. In the immediately preceding example, the second threshold period is set to equal the first period of disallowance of 30 minutes. Some embodiments may set the second threshold period to a different period than the first period of disallowance. Some embodiments may calculate periods of disallowance from the time associated with the first-added timestamp. However some embodiments may calculate periods of disallowance beginning with the expiration time of a threshold period.

The record associated with the example IP address may be deleted following the 24-hour period of disallowance if no additional threshold tiers have been exceeded. Alternatively, the first-added timestamp, the connection request count, and/or the disallow flag may be reset following a period of disallowance, as previously mentioned.

A third control tier may disallow additional connections from the offending IP address indefinitely or until a manual reset is performed. Various numbers and arrangements of control tiers, timers, timestamps, and threshold counters are contemplated for the embodiments disclosed herein for the purpose of dynamically throttling the rate at which remote clients using the same IP address are permitted to connect to a server to receive content.

The IP address database 114 may also comprise a table of allowed IP addresses 136. The table of allowed IP addresses 136 may be scanned by the dynamic proxy access logic 110. Remote clients attempting access with an IP address found in the table of allowed IP addresses 136 may be allowed to connect to receive the protected content. The IP address database 114 may further comprise a table of blocked IP addresses 138. The table of blocked IP addresses 138 may also be scanned by the dynamic proxy access logic 110. The dynamic proxy access logic 110 may disallow access by remote clients attempting access using an IP address found in the table of blocked IP addresses 138.

The apparatus 100 may also include allowed/blocked list import logic 140 coupled to the IP address database 114. The allowed/blocked list import logic 140 populates the table of allowed IP addresses 136 and the table of disallowed IP addresses 138.

The apparatus 100 may further include a geographic database 144 of IP address ranges. The geographic database 144 may store associations between IP address ranges and geographic regions. A geographic lookup engine 148 may be coupled to the geographic database 144 and to the remote client entry logic 106. The geographic lookup engine 148 may perform a lookup of an IP address associated with a connection attempt. The geographic lookup engine 148 may disallow the server connection if a geographic region associated with the IP address is included within a selected set of prohibited geographic regions.

Operating together, the dynamic proxy access logic 110 and the geographic lookup engine 148 may prevent access to content by large numbers of remote clients located in a geographic area for which the content is unlicensed. For example, the geographic lookup engine 148 may disallow remote clients with IP addresses that are associated by the geographic database 144 with Tokyo. At the same time, the dynamic proxy access logic 110 may disallow access by large numbers of remote clients located in Tokyo and attempting to access the content across a VPN terminating in New York City.

The apparatus 100 may also include a site redirection engine 152 coupled to the remote client entry logic 106. The site redirection engine 152 may redirect a disallowed connection request to an alternate Web page, or may present an error or advice message to the requesting remote client.

The apparatus 100 may further include an access management interface 156 coupled to the dynamic proxy access logic 110. The access management interface 156 may receive a set of risk profile configuration parameters associated with access to server content or other resources. In some embodiments, the access management interface 156 may comprise a user interface (UI). The set of risk profile parameters may be input via the UI by content management personnel associated with content owners, licensees, application service providers, or others.

The risk profile configuration parameters may include the threshold period, the threshold number, the period of disallowance, thresholds and periods of disallowance for higher-tiered threshold levels, an allowable set of geographic regions, and an allowed list/blocked list import schedule, among others. In some embodiments, the dynamic proxy access logic 110 may be configured to associate a separate set of risk profile configuration parameters with each content item.

In another embodiment, a system 180 may include one or more of the apparatus 100, including remote client entry logic 106 and dynamic proxy access logic 110. The dynamic proxy access logic 110 may disallow a server connection for a period of disallowance if a threshold number of connection attempts from remote clients with a common IP address exceeds a threshold number during a threshold time period. The common IP address associated with the remote clients may comprise a proxy server, including a VPN.

The system 180 may also include a Web hosting module 184. The Web hosting module 184 may serve content to remote clients that are allowed access by the mechanisms described above. The system 180 may further include a page rendering engine 186 coupled to the Web hosting module 184. The page rendering engine 186 may format the content according to page display capabilities at the remote clients. A content server 188 may be communicatively coupled to the Web hosting module 184 to provide the content.

Any of the components previously described may be implemented in a number of ways, including embodiments in software. Software embodiments may be used in a simulation system, and the output of such a system may provide operational parameters to be used by the various apparatus described herein.

Thus, the apparatus 100; the client entry logic 106; the dynamic proxy access logic 110; the IP address database 114; the active address table 118; the record 119; the IP address field 120; the provider field 122; the content item field 124; the first-added timestamp field 126; the connection request count field 128; the disallow flag 132; the disallow timestamp field 134; the table of allowed IP addresses 136; the table of blocked IP addresses 138; the list import logic 140; the geographic database 144; the geographic lookup engine 148; the site redirection engine 152; the access management interface 156; the system 180; the Web hosting module 184; the page rendering engine 186; and the content server 188 may all be characterized as “modules” herein.

The modules may include hardware circuitry, optical components, single or multi-processor circuits, memory circuits, software program modules and objects, firmware, and combinations thereof, as desired by the architect of the apparatus 100 and of the system 180 and as appropriate for particular implementations of various embodiments.

The apparatus and systems of various embodiments may be useful in applications other than restricting access to content by throttling the rate at which remote clients using the same IP address are permitted to connect to receive the content. Thus, various embodiments of the invention are not to be so limited. The illustrations of the apparatus 100 and of the system 180 are intended to provide a general understanding of the structure of various embodiments. They are not intended to serve as a complete or otherwise limiting description of all the elements and features of apparatus and systems that might make use of the structures described herein.

The novel apparatus and systems of various embodiments may comprise and/or be included in electronic circuitry used in computers, communication and signal processing circuitry, single-processor or multi-processor modules, single or multiple embedded processors, multi-core processors, data switches, and application-specific modules including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others. Some embodiments may include a number of methods.

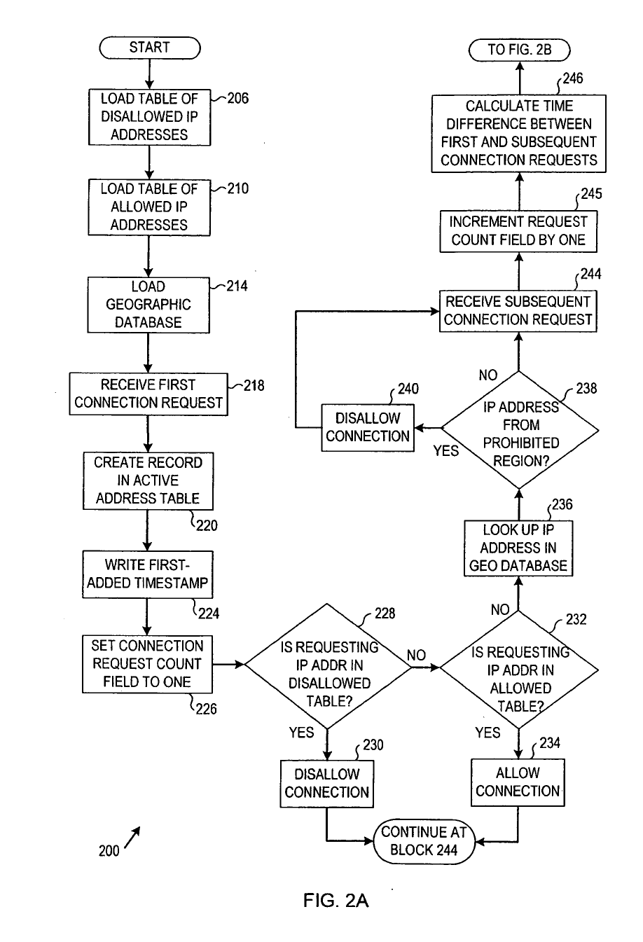

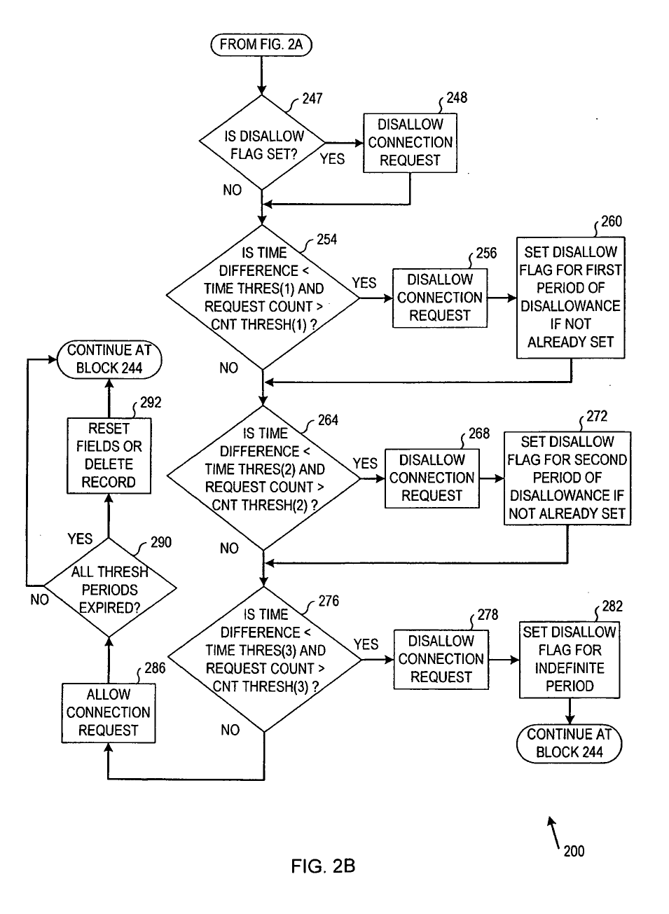

FIGS. 2A and 2B are flow diagrams illustrating several methods according to various embodiments. A method 200 may include disallowing connections to protected content or applications by one or more remote clients associated with a single IP address. Connections may be disallowed if the rate at which the remote clients attempt to connect exceeds a selected threshold. In some embodiments, the applications and/or protected content may be hosted by an application service provider.

Requests for the connections may be made via the Web, a local-area network, or other type of connectivity according to various embodiments. The client connections may be disallowed for a period of time, referred to herein as the period of disallowance, if a number of connection requests from the clients exceeds a threshold during a selected threshold time period.

The method 200 may commence at block 206 with loading a table of disallowed IP addresses. The table of disallowed IP addresses may contain IP addresses associated with remote clients for which a connection to a content server or an application server is known to be undesirable. For example, an IP address associated with an entity known to be associated with the spread of computer viruses may be included in the table of disallowed IP addresses.

The method 200 may continue at block 210 with loading a table of allowed IP addresses. The table of allowed IP addresses may contain IP addresses that are known to be allowable. For example, an IP address associated with a paid subscription to access protected content may be included in the table of allowed IP addresses.

The method 200 may also include loading a geographic database, at block 214. The geographic database may store associations between IP address ranges and geographic regions. Lookups in the geographic database may be made to filter access by remote clients according to geographic region.

The method 200 may further include receiving a first connection request from a remote client; at block 218. A record may be created in an active address table, at block 220. The record may include one or more of an IP address field populated with the IP address, a provider field populated with a provider identifier, a content item field populated with a content item identifier, a first-added timestamp field, a connection request count field, a disallow flag, and a disallow timestamp field.

The method 200 may also include writing a first-added timestamp into the first-added timestamp field, at block 224. The first-added timestamp may correspond to a time of arrival of the first connection request. The method 200 may further include setting the connection request count field to one, at block 226.

The method 200 may also include determining whether the requesting IP address is included in the table of disallowed IP addresses, at block 228. If so, a connection from the requesting IP address may be disallowed, at block 230.

If the IP address is not included in the table of disallowed IP addresses, the method 200 may continue at block 232 with determining whether the requesting IP address is included in the table of allowed IP addresses. If so, the connection from the requesting IP address may be allowed, at block 234.

If the IP address is not included in the table of allowed IP addresses, the method 200 may continue at block 236 with looking up the IP address in a geographic database of IP address ranges. The method 200 may determine whether the geographic region associated with the IP address is included within a selected set of prohibited geographic regions, at block 238. If so, the connection request may be disallowed, at block 240.

The method 200 may continue with receiving a subsequent connection request following the first connection request, at block 244, and with incrementing the connection request count field by one, at block 245. The method 200 may include calculating a time difference between the time of arrival of the first connection request and the time of arrival of the subsequent connection request, at block 246.

The method 200 may also determine whether the disallow flag is set, at block 247. If so, the subsequent connection request may be disallowed, at block 248. In either case, the method 200 may continue at block 254 with determining whether the time difference is less than the first threshold period and the connection request count field contains a count greater than the first threshold number. If so, the method 200 may include disallowing the request, at block 256, and initiating a first period of disallowance if not already initiated, at block 260. Periods of disallowance may be initiated by setting the disallow flag.

Whether or not the time difference is less than the first threshold period and the connection request count field contains a count greater than the first threshold number, some embodiments may test for additional threshold values. In that case, the method 200 may continue at block 264 with determining whether the time difference is less than a second threshold period and the connection request count field contains a count greater than a second threshold number. If so, the subsequent connection request may be disallowed, at block 268, and a second period of disallowance may be invoked, at block 272.

Whether or not the time difference is less than the second threshold period and the connection request count field contains a count greater than the second threshold number, some embodiments may test for a third tier of threshold values. In that case, the method 200 may continue at block 276 with determining whether the time difference is less than a third threshold period and the connection request count field contains a count greater than a third threshold number. If so, the subsequent connection request may be disallowed, at block 278, and additional subsequent requests may be disallowed for an indefinite time period, at block 282. Some embodiments may add the IP address to the table of disallowed IP addresses when the third and final tier of disallowance is invoked. The method 200 may continue at block 244.

If the time difference is not less than the third threshold period or the connection request count field does not contain a count greater than the third threshold number, the connection request may be allowed, at block 286.

The method 200 may also include determining if all threshold periods have expired, at block 290. If so, one or more of the first-added timestamp, the connection request count, and the disallow flag may be reset, at block 292. Alternatively, the IP address record may be deleted from the active address table. In either case, the method 200 may continue at block 244.

It is noted that, while the example embodiments described use three threshold tiers, some embodiments may use other numbers of tiers. In lieu of the afore-described stepped tiers of threshold periods, some embodiments may invoke periods of disallowance if the instantaneous access request rate, measured at the time of receipt of each subsequent request, is above a threshold value. That is, if at the time of receiving a subsequent request, the value of the connection request counter divided by the time elapsed from the time recorded in the first-added timestamp field is above a threshold rate, a period of disallowance may be invoked.

The activities described herein may be executed in an order other than the order described. The various activities described with respect to the methods identified herein may also be executed in repetitive, serial, and/or parallel fashion.

A software program may be launched from a computer-readable medium in a computer-based system to execute functions defined in the software program. Various programming languages may be employed to create software programs designed to implement and perform the methods disclosed herein. The programs may be structured in an object-oriented format using an object-oriented language such as Java or C++. Alternatively, the programs may be structured in a procedure-oriented format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

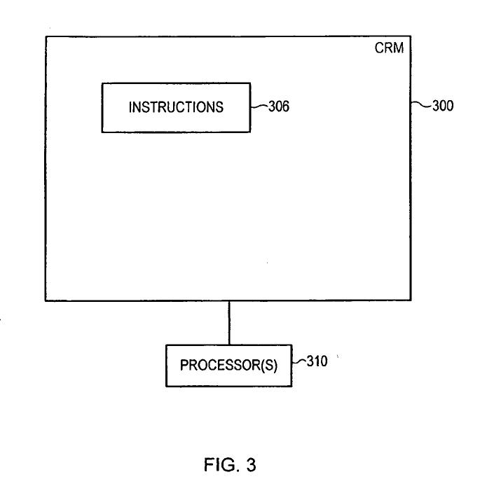

FIG. 3 is a block diagram of a CRM 300 according to various embodiments of the invention. Examples of such embodiments may comprise a memory system, a magnetic or optical disk, or some other storage device. The CRM 300 may contain instructions 306 which, when accessed, result in one or more processors 310 performing any of the activities previously described, including those discussed with respect to the method 200 noted above.

The apparatus, systems, and methods disclosed herein may restrict access to content or to server-based applications by throttling the rate at which multiple remote clients using the same IP address are permitted to connect to receive the content or to access the applications. A coarse granularity of control may be exercised even when login accounts are not used for access. This access restriction paradigm may be useful for very high-volume simultaneous access to Internet content such as a sporting event broadcast in real time, and may be used to enforce content licensing agreements.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims and the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
remote client entry logic to receive a request for a connection from at least one remote client associated with an Internet protocol (IP) address, the connection requested to receive protected content; and
dynamic proxy access logic coupled to the remote client entry logic to disallow additional connections for a period of disallowance if a number of connection requests from the at least one remote client exceeds a threshold number during a threshold time period.

2. The apparatus of claim 1, wherein the IP address is associated with a proxy agent.

3. The apparatus of claim 1, further including:
an IP address database coupled to the dynamic proxy access logic, the IP address database further comprising:
an active address table to store the number of connection requests;
a table of allowed IP addresses to be scanned by the dynamic proxy access logic to allow the connection if the IP address is found in the table of allowed IP addresses; and
a table of blocked IP addresses to be scanned by the dynamic proxy access logic to disallow the connection if the IP address is found in the table of blocked IP addresses.

4. The apparatus of claim 3, wherein a record from the active address table comprises an IP address field containing the IP address and at least one of a provider field, a content item field, a first-added timestamp field, a connection request count field, a disallow flag, or a disallow timestamp field.

5. The apparatus of claim 3, further including:
allowed/blocked list import logic coupled to the IP address database to populate the table of allowed IP addresses and the table of disallowed IP addresses.

6. The apparatus of claim 1, further including:
a geographic lookup engine coupled to the remote client entry logic to perform a lookup of the IP address and to disallow the connection requests if a geographic region associated with the IP address is included within a selected set of prohibited geographic regions; and
a geographic database of IP address ranges coupled to the geographic lookup engine, each range associated with a geographic region.

7. The apparatus of claim 1, further including:
a site redirection engine coupled to the remote client entry logic to redirect a disallowed remote client to an alternate Web page.

8. The apparatus of claim 1, further including:
an access management interface coupled to the dynamic proxy access logic to receive a set of risk profile configuration parameters associated with the connection.

9. The apparatus of claim 8, wherein the risk profile configuration parameters include at least one of the period of disallowance, the threshold number, the threshold time period, an allowable set of geographic regions, or an allowed list/blocked list import schedule.

10. The apparatus of claim 8, wherein the dynamic proxy access logic is configured to associate a separate set of risk profile configuration parameters with each content item.

11. A system, comprising:
remote client entry logic to receive a request for a connection from at least one remote client associated with an Internet protocol (IP) address, the connection requested to receive protected content;
dynamic proxy access logic coupled to the remote client entry logic to disallow additional connections for a period of disallowance if a number of connection requests from the at least one remote client exceeds a threshold number during a threshold time period; and
a World-wide Web hosting module coupled to the remote client entry logic to serve content to the at least one remote client if the connection is granted.

12. The system of claim 11, wherein the IP address is associated with a proxy server.

13. The system of claim 11, wherein the IP address is associated with a virtual private network connection.

14. The system of claim 11, further including:
a page rendering engine coupled to the Web hosting module to format the content according to page display capabilities at the at least one remote client.

15. The system of claim 11, further including:
a content server communicatively coupled to the Web hosting module to provide the content.

16. A method, comprising:
disallowing connections from at least one remote client associated with an Internet protocol (IP) address for a period of disallowance if a number of connection requests from the at least one client exceeds a first threshold number during a first threshold time period.

17. The method of claim 16, further including:
receiving a first connection request from the at least one remote client; and
creating a record in an active address table, wherein the active address table includes an IP address field populated with the IP address and at least one of a provider field populated with a provider identifier, a content item field populated with a content item identifier, a first-added timestamp field, a connection request count field, a disallow flag, or a disallow timestamp field.

18. The method of claim 17, further including:
writing a first-added timestamp into the first-added timestamp field, the first-added timestamp corresponding to a time of arrival of the first connection request; and
setting the connection request count field to one.

19. The method of claim 18, further including:
responding to a subsequent connection request following the first connection request by incrementing the connection request count field by one;
calculating a time difference between the time of arrival of the first connection request and a time of arrival of the subsequent connection request;
initiating the period of disallowance if the time difference is less than the first threshold period and the connection request count field contains a count greater than the first threshold number; and
disallowing at least one class of subsequent connection requests received during the period of disallowance.

20. The method of claim 19, further including performing at least one of:
resetting at least one of the first-added timestamp, the connection request count, or the disallow flag following the expiration of at least one of the first threshold period or the second threshold period; or
deleting the record from the active address table.

21. The method of claim 19, further including:
initiating an additional period of disallowance if the time difference is less than a second threshold period and the connection request count field contains a count greater than a second threshold number; and
disallowing the at least one class of subsequent connection requests received during the additional period of disallowance.

22. The method of claim 21, further including:
disallowing the at least one class of subsequent connection requests for an indefinite time period if the time difference is less than a third threshold period and the connection request count field contains a count greater than a third threshold number.

23. The method of claim 16, wherein the connection requests are made via a World-wide Web.

24. The method of claim 16, further including:
denying a connection to an application hosted by an application service provider.

25. The method of claim 16, further including:
disallowing a connection from the at least one remote client if the IP address is included in a table of disallowed IP addresses.

26. The method of claim 16, further including:
allowing a connection from the at least one remote client if the IP address is included in a table of allowed IP addresses.

27. The method of claim 16, further including:
looking up the IP address in a geographic database of IP address ranges; and
disallowing the connection if a geographic region associated with the IP address is included within a selected set of prohibited geographic regions.

28. The method of claim 25, claim 26, or claim 27, further including:
receiving at least one of the table of disallowed IP addresses, the table of allowed IP addresses, or the geographic database.

29. A computer-readable medium having instructions, wherein the instructions, when executed, result in at least one processor performing:
disallowing connections from at least one remote client associated with an Internet protocol (IP) address for a period of disallowance if a number of connection requests from the at least one client exceeds a threshold number during a threshold time period.

30. The computer-readable medium of claim 29, wherein the instructions, when executed, result in the at least one processor performing:
looking up the IP address in a geographic database of IP address ranges; and
conditionally allowing a first connection if a geographic region associated with the IP address is included within a selected set of geographic regions.
